(19) United States
(12) Patent Application Publication
(10) Pub. No.: US 2004/0071281 A1
(43) Pub. Date: Apr. 15, 2004

(54) Telephony method, system and application for barring personal calls outside a local telephony system

(76) Inventor: Abid T. Rashid, Berkshire (GB)

Correspondence Address: LARSON & TAYLOR, PLC, 1199 NORTH FAIRFAX STREET, SUITE 900, ALEXANDRIA, VA, 22314, US

(21) Appl. No.: 10/269,087

(22) Filed: Oct. 11, 2002

(51) Int. Cl. H04M 3/42; H04M 3/00

(52) U.S. Cl. 379/210.02; 379/265.02; 379/266.03

(57) ABSTRACT

A telephony method and system are provided in a local telephony system for selectively barring calls outside the system for a system user including the steps of/means for: compiling a list of telephone numbers tagged as personal number specific to the user; determining a busy time when there is a level of call activity above an activity threshold; and barring specific user calls corresponding to the personal numbers during the busy time. A soft call-barring application (and database schema) for carrying out the method is also provided.

### FIELD OF THE INVENTION

This invention is in the field of telephony and has particular application in the field of Computer Telephony Integration (CTI) used predominantly in call centres and offices.

### BACKGROUND OF THE INVENTION

Telephones as we currently know are one of the most widely used communication tools in the world. At first, telephones were merely a convenient tool to allow people to communicate while they were physically separated. More recently, however, many companies use telephones to market products and services, provide technical support to customers, and allow customers to access their own financial data.

In order to use telephones more effectively for business and marketing purposes, call centres have been developed. In a call centre, a relatively large number of agents handle telephone communication with customers of the company. The matching of calls between customers and agents is typically performed by software.

At the time of filing the present patent application there continues to be remarkable growth in telephone-based contact centres (or call centres) in their most basic form. Recently emerging examples are telemarketing operations and technical support operations, among many others, which have grown rapidly with development and marketing of, for example, sophisticated computer equipment. Likewise there are many more traditional call centres for serving customers of large insurance companies, banks and telecommunication companies. Newer companies are outsourcing call centre operations to firms that specialise in such services which are in turn driven by efficiency within the call centre.

In a call centre, a relatively large number of agents handle telephone communication with customers. Each agent is typically assigned to a telephone connected to a central switch, which is in turn connected to a public-switched telephone network (PSTN). The central switch may be one of several types, such as Automatic Call Distributor (ACD) or Private Branch Exchange (PBX) or PSTN.

If the call centre consists of just a central switch and connected telephone sets, the call control that can be done is very limited. Switches, such as ACD, PBX, PSTN and the like, although increasingly computerised, are limited in the range of computer processes that they may perform. For this reason additional computer capability in the art has been added for such central switches by connecting computer servers adapted to run control routines and to access databases. The processes of incorporating computer enhancement to telephone switches is known in the art as Computer Telephony Integration (CTI), and the hardware used is referred to as CTI equipment and the associated software as CTI software.

A simple example is used here to describe a few of the many advantages of using CTI call centres. When a call is made to a call centre, the telephone number of the calling line also know as Calling Line Identification (CLI) or Automatic Number Identification (ANI), is typically made available to the call centre by the telephone carrier. Based on this telephone number, the CTI software in the call centre connected to the telephone switch can perform a database lookup to obtain information about the customer who has that telephone number. The CTI software can then better route the call to an agent who can best handle the call based on predefined criteria (e.g., language skill, knowledge of products the customer has bought, etc.). The CTI software also immediately transfers relevant information about the client to a computer screen used by the agent. In this way, the agent can gain valuable information about the customer prior to receiving the call. As a result of this, the agent can more effectively handle the telephone transaction.

It can be seen from the above example that the enabling technology requires a combination of telephone switching and computer information processing technologies and the combined technology is Computer Telephony Integration (CTI).

One of the major goals of any call centre is to ensure customer satisfaction. Part of the satisfaction that a customer receives from doing business with a company relates to how quickly he or she was served. For example, when a customer calls in to place an order for a product or service, he or she does not want to be put on hold for a lengthy period of time. This is especially true with company-to-company buying of products or services. A typical buyer has many duties that can be interrupted because of inordinate amounts of time spent waiting to place an order. In these types of situations, idle time costs money, and in many cases, cannot be tolerated. Many orders are lost by companies who put callers in long waiting queues only to have the caller hang up and go to a competitor for service. Anyone who has experienced dealing with call centres will agree that much improvement is needed regarding reducing the long queuing times.

Intelligence in the routing of calls within call centres has helped in improving customer satisfaction. But this alone only improves automation of the connection of the customer to an agent. Likewise, increasing the availability of an agent is a matter which needs equal attention. If agents can be assisted in being more available to take calls, the average waiting time for calls can be reduced leading to an overall improvement in customer satisfaction.

What is clearly needed is a method and system for implementing an environment where agents are available for the maximum amount of time. This means ensuring that agents are not unavailable for reasons which have no connection to their work routine e.g. taking or making calls of a personal nature. By lessening the effects of these perks of the job, it is possible to maximise the agent availability within a call centre and this has direct impact on how quickly calls can be answered.

Typically it is possible to bar certain numbers from being dialled through a Private Branch Exchange by adding these to some internal configuration tables. This has the effect of being a global rule which affects all calls to that particular telephone number. This approach has the disadvantage that it is inflexible and, if misapplied, could prevent a business calling its own customers since their numbers may also be barred.

### SUMMARY OF THE INVENTION

The invention is defined in the independent claims, to which reference should now be made. Preferred features are set out in the sub-claims.

According to the invention there is provided a telephony method in a local telephony system for selectively barring calls outside the system for a system user including the steps of: compiling a list of telephone numbers tagged as personal numbers specific to the user; determining a busy time when there is a level of call activity above an activity threshold; and

barring specific user calls corresponding to the personal numbers during the busy time.

Reference herein to personal calls should be taken to include any low priority calls that do not contribute to the business operating the local telephony system and that are specific to a user (for example, calls to relatives, friends, other non-work contacts and telephone banking services or the like).

This method of intelligent call barring (also referred to herein as soft call-barring as opposed to hard call-barring which is an absolute bar) allows agent productivity to be improved in a CTI call centre. However, since personal calls are allowed at times of lower system activity, it is unlikely to alienate the staff, and thus should not aggravate the already high turnover rates prevalent in call centres. The same concept applies when the soft call barring is used in a local telephony system for a standard office set-up.

The threshold for soft call barring may be set according to a number of factors. In one embodiment, specific user calls are barred according to a pre-calculated busy period. For example they may be barred when the call centre is typically at its busiest, for example 9:30 am to 11:30 am.

Alternatively, calls may be barred by globally monitoring queued calls to determine a busy period. For example, switch service level may be used to monitor system activity or the CTI reporting function could fulfil the same function.

As a further alternative, calls are barred by personal monitoring in dependence upon agent workload to determine a busy period. In this scenario, calls and tasks queued for each agent are monitored in the CTI system.

The calls may be tagged in various classes with differing priority levels, the lower priority levels having differing barring thresholds. For example, calls may be tagged by allocating them to the classes of personal, any intermediate classes, (such as unknown or other) and business. In this case, personal calls would have the lowest threshold, any intermediate classes higher thresholds and business calls would not be soft barred. That is, no threshold would be set for business calls.

The list of telephone numbers may be compiled by tagging numbers in a periodic review of calls for each user. For example, the periodic review may automatically highlight numbers associated with unusual call behaviour. Thus numbers called more than an average number of times and/or numbers called for more than a certain amount of time may be highlighted. Further review would then include manager and/or user input (for instance in an interview) to decide how the highlighted numbers are to be classified.

In one preferred embodiment usual business telephone numbers are imported into the system before calls are made and any other numbers are automatically recorded as non-business until they have been classified and their numbers tagged. Alternatively, all calls can be assumed to be of business nature, before classification.

Additionally or alternatively, the list of telephone numbers may be updated as a result of a(n) (incoming or outgoing) call. This is particularly appropriate when the number has not been previously tagged and can be an automatically prompted step for the system user if the system identifies the outside number as untagged. This call-specific tagging may be carried out by the user as the call is reported by the user in a call wrap stage. Alternatively, the tagging may be carried out at a call attempt stage.

Since the method can be implemented in software, it may use (intelligent) rules or filters to selectively bar numbers in addition to the user-specific soft-barring.

Preferably, the method bars all calls to certain numbers, classified as global bar numbers. The global bar numbers may be, for example, premium-rate chat lines or the like. Furthermore, predetermined user group bar numbers may be barred to certain groups of users. Such additional barring may also be dependent on system activity but is more likely to be a complete (or hard) bar. User-specific hard-barring is also contemplated.

Any additional barring may refer to number ranges rather than a single number. For example, international calls (starting with “00”) may be barred for everyone below a certain level in the business hierarchy. This is a group bar to a range of numbers, where the group is probably formed by the majority of the system users.

The wide variety of bars available according to embodiments of the present invention can also be termed as call filters and are held as rules in a database. Each rule may be static or dynamic (load dependent).

The method is preferably a computer telephony integration (CTI) method. The CTI system may be based on a single or on multiple sites.

In one preferred embodiment the system user is an agent in a call centre and the local telephony system is a call centre.

In another preferred embodiment, the system user is an office worker and local telephony system is a private branch exchange (PBX).

In yet another preferred embodiment at least one system user may be a remote agent/office worker connected over a network (such as the public switched telephone network) to the local telephony system.

In a further aspect, the present invention also relates to a telephony method in a local telephony system for screening and selectively barring calls outside the system for a system user including the steps of:

the user receiving or making a telephone call outside the system; classification of the call according to how the outside number is tagged in a database of outside numbers; checking appropriate call filters; barring the call if the number is tagged as personal and the level of call activity is above a certain threshold; and allowing the call to proceed if it has not been barred. Preferably the appropriate call filters are for the call classification and for the global or local level of call activity.

Preferably, the method includes the step of checking the database for call filters other than user-specific soft call barring, such as total, specific or group bars (as mentioned previously) and barring the call if there is another bar on the number which is relevant to the user. This step is preferably carried out before checking the level of system activity if the other filters are time independent to avoid a possibly unnecessary processing step.

The method preferably includes an initial step of the user logging into system, preferably by entering an ID code. The user may log out after the call but more usually only logs out when leaving his or her workstation unmanned, to avoid unauthorised used of his or her ID.

The method also preferably includes the step of updating call records once the call has been successfully completed or rejected. The call records may then be used in the review stage described above.

The method of embodiments of the invention is suitable to bar both incoming and outgoing calls.

In a further aspect, the invention relates to a local telephony system suitable for attachment to the public switched telephone network (PSTN) comprising a telephony switch for call distribution within the local system; at least one telephone attached to the switch, a computer system connected to the switch, including a database containing telephone numbers outside the local system selectively tagged as personal numbers specific to a system user and at least one filter to disallow personal calls during times when there is a level of activity above a certain threshold; and a soft call barring application in communication with the database, wherein the soft call barring application selectively bars specific user calls corresponding to personal numbers during the busy time.

In a still further aspect, the invention relates to a local telephony system suitable for attachment to the public switched telephone network (PSTN) comprising a telephony switch for call distribution within the local system; at least one telephone attached to the switch, a computer system connected to the switch, including a database containing telephone numbers outside the local system selectively tagged as personal numbers specific to a system user and at least one filter to disallow personal calls during times when there is a level of activity above a certain threshold; a CTI function attached to the switch and the database and a soft call barring application in communication with the database and CTI function, wherein the soft call barring application selectively bars specific user calls corresponding to personal numbers during the busy time.

Although some users may not have access to a computer, most have access to a computer, which is preferably on the same computer network as the soft call barring application, database and CTI function.

In a preferred embodiment, the system user's telephone is connected to the switch and the system user's computer (when there is one) is connected to the computer network with no direct communication between the telephone and computer. This arrangement is known as third party CTI.

The CTI function may be as part of a “soft switch” (a telephony switch with embedded CTI software). More usually, the CTI function is provided as a CTI server linking the switch to the computer system.

The system may also incorporate a SOHO (single office/home office) facility. In this case a home worker may be connected to the local telephony system over a telephone network. Signals from the home worker's computer and telephone are preferably multiplexed together over the telephone network and de-multiplexed before input into the switch.

The switch itself may be any suitable telephony switch, such as an ACD (automatic call distribution) switch or a PBX.

In a further aspect, the invention relates to a soft call barring application (and preferably a suitable database schema) for use in a local telephony system comprising suitable functionality for carrying out the method of any of the above-mentioned method steps.

The database schema may, however, be available pre-installed in a computer system. The soft call-barring application receives notification of calls, checks the database for any filters and sends a barring command to a CTI system when required by the rules/filters in the database. The application (and database schema) is suitably software, that is, a computer program or set of computer programs. It is preferably provided on a suitable carrier. Thus the present invention may be embodied in a computer program. The computer program may be stored on a computer-readable medium, or it could, for example, be embodied in a signal such as a downloadable data signal provided from an Internet web site. The appended computer program (and application) claims are to be interpreted as covering a computer program by itself, or as a record on a carrier, or as a signal, or in any other form.

It will be clear to the skilled man that the aspects enumerated above may be combined where not obviously incompatible. In particular, features of the method embodiments have equivalent system parts, preferably in terms of the required software functionality or mixed software/hardware functionality.

### BRIEF DESCRIPTION OF THE DRAWINGS

Preferred features of the present invention will now be described, purely by way of example, with reference to the accompanying drawings, in which:

FIG. 1 is a block diagram depicting the layout of a call centre according to a preferred embodiment of the present invention;

FIG. 2 is a simplified flow diagram illustrating operative steps of the determination call control routine according to the embodiment of the present invention;

FIG. 3 is a simplified flow diagram illustrating operative steps of the “filtering by exclusion” reporting and tagging of the call records according to the embodiment of the present invention; and

FIG. 4 is a simplified flow diagram illustrating operative steps of the “filtering by inclusion” reporting and tagging of the call records according to the embodiment of the present invention.

### DETAILED DESCRIPTION OF THE PREFERRED EMBODIMENTS

Embodiments of this invention provide a method for safely determining whether a user of Computer Telephony Integration software and a Private Branch Exchange (PBX) is making or receiving a personal call and then enforcing rules of preventing this call being made.

The concept starts by allowing the user (and/or his/her manager) to tag each call as to whether it is of a business or personal type. This would, for example, be done at the time when either the call is initially dialled or when the call is being received. Thus, whenever a personal call is either made by a user or received, the software can receive the level of activity within the location where the user is based and determine if the call is to allowed to take place or is to be dropped.

The method of actually determining what numbers are personal may be made at both the time of making the call, and also through the updating of reports which indicate the frequency with which certain telephone numbers have been called. This report can reflect any period of time during which the system has been active and show potential anomalies in calling patterns which could indicate personal calls or non-business calls.

One embodiment of this invention is in the application of call centres. Call centre agents would be requested to tag each outbound call as to whether it is of a business of personal nature. Typically such agents would have telephone sets which would be unbarred and hence able to make calls to all types of external numbers. When an agent makes an outbound call to another party either using software on the computer desktop or via the telephone set, the Computer Telephony Integration system would pass the information of this call request to this software. The software would then check to see if the number being dialled is listed as a personal number for that particular user and also the level of activity within the call centre.

If the number can be confirmed as being a personal call and the call centre activity is determined to be above a certain threshold of activity, the software would then make a request via the computer telephony system to disallow the call. This whole process of determining and dropping the call would take place within a sub-second time period. Over a period of time the software would capture information about all personal and business calls made. It would then present this in a form by which a manager could determine the telephone numbers dialled along with the frequency of calls to that number. At this point it would be a fairly intuitive for the agent and the manager to mark which calls are personal and hence update the filters within the system. Anomalies within this report would show up as certain telephone numbers being accessed more so than others.

One advantage of the embodiments of this invention is that they allow managers of the software to determine how many personal calls are made and received and then enforce intelligent rules within the software to control these calls. This mechanism could include filters to completely disallow certain types of calls being dialled or could place restrictions on certain groups of users from making certain types of calls.

One embodiment of this rule would be applied in call centres that handle inbound and outbound calls. If the number of inbound calls at any time exceeds the capacity of agents working then calls start to queue. This software could determine that if the number of queuing calls exceeds a set value, all further outbound personal calls would be barred. Then when the number of queuing calls falls below this set value, the system would then again allow personal outbound calls to be made.

Embodiments of this invention can be deployed in a single or multiple site deployment of Computer Telephony Integration on a Private Branch Exchange or Automatic Call Distribution Systems. They are of use to both call centre agents and to back office workers who have a Computer Telephony Integration system connected to their Private Branching Exchange. They can handle calls that are made out of the system and referred to as outbound calls and calls made into the system and referred to as inbound calls. They cover the application at an individual user level, and at a higher group level as reflected within Automatic Call Distribution Systems and Computer Telephony Integration Routing Systems. They can cope with users who have Computer Telephony Integration desktop clients and those who do not. This system can deal with static filters as defined by fixed rules of which calls to allow or prevent or dynamic filters based on feedback from the system as to the load.

Telephone call processing and switching systems are at the present time relatively complex computer systems. Much information on the nature of such hardware and software associated with these systems is available in a number of publications accessible to the present inventors and to those with skills in the art in general. For this reason, much minute detail of known system is not reproduced, as to do so would obscure the facts of the invention.

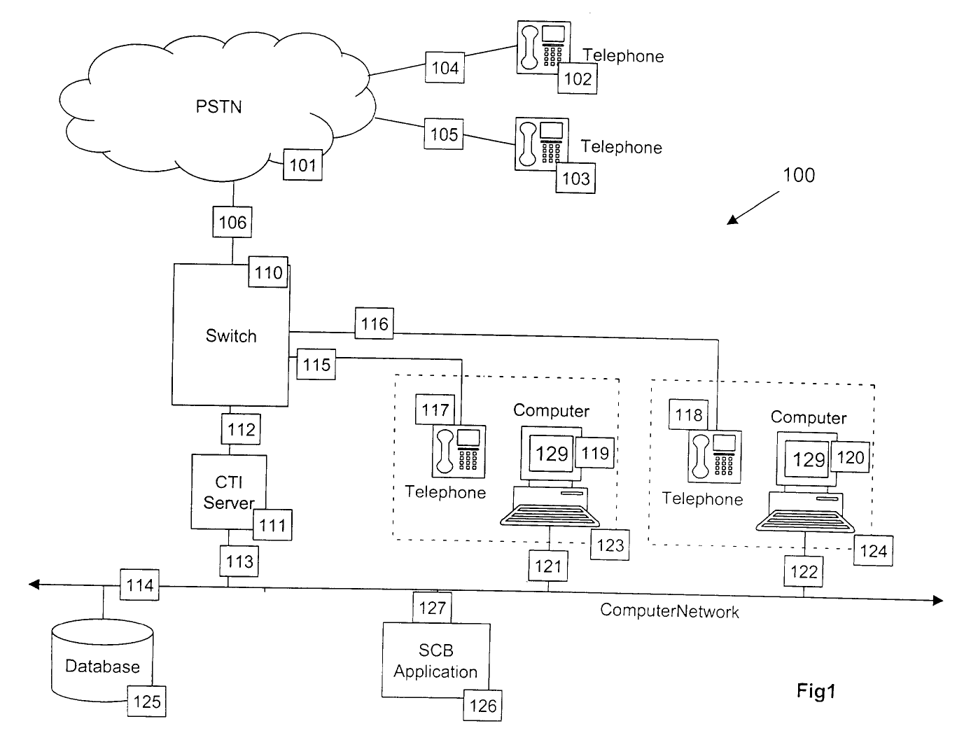

FIG. 1 is a block diagram of an office system which can be used to implement this invention. Office 100 is connected to the Public Switching Telephone Network (PSTN) 101. Switch 110 is used for receiving calls from the PSTN 101 and also for making calls to the PSTN 101 via trunks 106. Switch 110 can be an Automatic Call Distributor (ACD), Private Branch Exchange (PBX), Private Automatic Branching Exchange (PABX), PSTN switch or a Voice over Internet Protocol (VoIP) Switch or a VoIP Gateway. The switch could alternatively be a PC equipped with the suitable voice cards to form a so-called PCX (PC exchange) also referred to as an un-PBX or soft switch.

Switch 110 is connected to the Local Area Network (LAN) 114 via the CTI-Server 111. The application 126 is connected to the LAN 114 and to database 125. Application 126 monitors all call activity in the switch 110 via the CTI Server 111 and records this into the database 125.

Within office 100 there are many computers equipped with corresponding telephone sets. For instance desk 123 contains a computer 119 and telephone 117. This desk forms a working habitat for an employee of the office. Another such desk is desk 124 containing a telephone 118 and computer 120. All telephones are connected to switch 110 and all computers are connected to the LAN 114.

A user typically initiates activity by requesting a login to the telephone set. This allows the switch to authenticate the user to use that telephone set. The relationship between telephone 117 and computer 119 is such that any usage and subsequent change of state of telephone 117 is posted to computer 119 via the CTI Server 111. This telephone to switch to CTI Server to computer link is commonly referred to as third-party CTI. This framework is deployed in its entirety where all telephones connected to the switch have all status change messages posted to the central application 126. In this way soft call-barring (or SCB) application 126 receives information about all current telephony usage and the kinds of services rendered, for inbound and outbound calls. Application 126 communicates with database 125 to store all information about telephone usage and which agent is using which telephone set at what time to conduct what type of call. Application 126 also retrieves filters and rules from database 125 regarding how call attempts are to be processed.

It has been found that the current functionality provided in a standard switch is rather limited and cannot meet the requirements of barring calls of a specific nature. For example is it desirable that certain non-core calls are barred from being made by the PABX. The current functionality within the switch is only capable of global barring that number from being dialled by any internal party. It is incapable of deciding which user is to be prevented from dialling which number on a user by user basis. Furthermore it is incapable of deciding when to prevent such calls based on load limits, priorities and other types of filters.

Embodiments of the invention rely on providing off-board intelligence to switch 110 in the form of application 126 to decide in more detail which calls are permitted to be made based on, for example, who is attempting the call, what number or number range is being dialled, what time of day it is, how busy the switch is and what other priority work remains to be completed before such calls can be made. Furthermore, extended filters can be programmed in as rules which can allow or disallow calls based on other system wide parameters.

The SCB application connects to the switch through a technology called Computer Telephony Integration (CTI) 111. As a way of implementing CTI, office 100 contains a CTI server 111 connected to the switch via an interface 112. Interface 112 can be of an X.25 nature or of a TCP/IP nature. The CTI Server then bridges this interface on the computer network 114 via an interface 113. This interface is typically of the TCP/IP nature. This system allows notification messages from the switch 110 to be passed onto client applications on the computer network 114 and relays requests back from these client applications to the switch 110.

The invention relies on server software application 126 which monitors all telephone status messages from the switch 110.

An aspect of this invention relies on the creation of rules and filters that decide which calls to allow or disallow and when to perform these actions. A part of this requires telephone number identification which takes place by a user correctly entering non-business (i.e. personal) telephone numbers into database 125. This input session may be based on joint action by the user and his manager.

The fact finding part of this process is when the application shows calls with details such as telephone numbers, dates and frequencies of call to and from that number to an individual user for a given time period. In the light of this information it is straightforward to detect anomalous calling patterns with personal and other non-business calls amounting to the majority of the call volume in frequency.

One example of this is a report showing all calls between a begin and end date and showing the telephone numbers and the frequency of calls made to that number. Any number that has been called more than the average number of times can be classified as suspicious and possibly of a non-business nature.

Outbound Call Example

In one embodiment of the present invention Office 100 could be a call centre and Switch 110 could be an Automatic Call Distributor (ACD). The same basic layout could apply with a normal ‘back office’ system.

Call centre agent is seated at the desk 123 with telephone 117 having a DN 7101 and computer 119. The computer is connected to the computer network 114 and the telephone is connected to the switch 110. Telephone 117 is enabled through CTI and all message associated with this telephone set are distributed by the CTI Server 111 to client applications such as the SCB application 126 and the CTI desktop application 129 also commonly referred to as SoftPhone.

The agent proceeds to login into the switch via the telephone set by entering in an Agent Identification (Agent ID) code into the keypad on the telephone. This prepares the telephone set for the use by the agent. This same login step can also be commissioned from the computer 119. All further actions performed on this particular telephone set will be connected to the said agent record until such time the agent decides to log off from the switch by pressing suitable buttons on the telephone set. Agent decides to use the telephone 117 to make a call. The agent lifts the handset on the telephone 117 and hears a dial tone on the telephone receiver. The agent then proceeds to enter in the telephone number 08707653801 via the telephone keypad. The agent could also dial the number using a Softphone application 129 on computer 119. This telephone number is then sent to the switch 110 via the telephone. The switch then passes a corresponding CTI message to the CTI Server 111. This message contains the following information: identification details of the telephone 117 i.e. the Directory Number (DN) 7101, the number dialled (08707653801), the Agent ID (1101) and a unique identification number for this call attempt.

This message is received by the application 126 from the CTI Server 111. Application 126 then proceeds to classify the call. It passes the number dialled 08707653801 and the Agent ID 1101 to database 125 to find out which category of call this is in relation to the agent. Database 125 returns a type such as “business”, “personal” or “other”. This signifies to the application that this call is recognised as being of a business nature, of a personal nature or of some other. If there is no record of this call in the database, the agent is prompted to classify the call as business or personal through a pop-up screen on computer 119.

The application then proceeds to check with the database to see whether calls of this nature can be made at this particular time. The database responds based on rules which govern outbound calls. The database checks to see if this person is authorised and not barred from calling this number. It then checks to see if the system is allowing calls of this nature to be made at this particular time based on current load levels. The response from the database is an approval or denial of the call to proceed.

If the response is an approval, no further action needs to be taken. If the response had been a denial, then application 126 would send a “hang-up call” message to the CTI Server which would then drop this call. Application 126 would then record the details of this call within database 125.

Inbound Call Example

Another embodiment of this present invention could be from an office with Switch 110 being a Private Branching Exchange (PBX). The same basic procedure applies to a call centre, which is more usually provided with an ACD switch.

Office employee is seated at the desk 123 with telephone 117 having DN 7101 and computer 119. The computer is connected to the computer network 114 and the telephone is connected to the switch 110. Telephone 117 is enabled through CTI and all messages associated with this telephone set are distributed by the CTI Server 111 to client applications such as the invention application 126 and the CTI desktop application 129.

The Employee proceeds to login into the switch via the telephone set by entering in an Agent Identification (Agent ID) code into the keypad on the telephone. This prepares the telephone set for the use by the employee. This same login step can also be commissioned from the computer 119. As before, all further actions performed on this particular telephone set will be connected to the user record until such time the employee decides to log off from the switch by pressing suitable buttons on the telephone set.

The employee receives an incoming call with call ID. The origination number of the call is 08707653801. This call origination would either arrive as the Calling Line Identification (CLI) or Automatic Number Identification (ANI) or some other property referring to the other party. The call arrival is reflected by telephone 117 ringing and a concurrent message being posted to the agent SoftPhone 129 on computer 119 via CTI Server 111. This message contains the following information, identification details of the telephone 117 i.e. the Directory Number (DN) 7101, the number of the calling party 08707653801, the Agent ID 1101 for employee 131 and a unique identification number for this call attempt.

This message is received by the application 126 from the CTI Server 111. Application 126 then proceeds to classify the call. It passes the calling party number 08707653801 and the Agent ID 1101 to database 125 to find out which category of call this is in relation to the agent. Database 125 returns a type such as “business”, “personal” or “other”. This signifies to the application that this call is recognised as being of a business nature, of a personal nature or of some other.

The application then proceeds to check with the database to see whether calls of this nature can be received at this particular time. The database responds based on rules which govern inbound calls. The database checks to see if this person is authorised and not barred from receiving this call. It then checks to see if the system is allowing calls of this nature to be received at this particular time based on current load levels. The SCB application then processes this data to decide whether this call can proceed or is to be disallowed.

If the response is an approval, no further action needs to be taken. If the response had been a denial, then application 126 would send a “hang-up call” message to the CTI Server which would then drop this call. Application 126 would then record the details of this call within database 125.

In this manner unapproved incoming calls which can be identified are prevented from reaching employee 131.

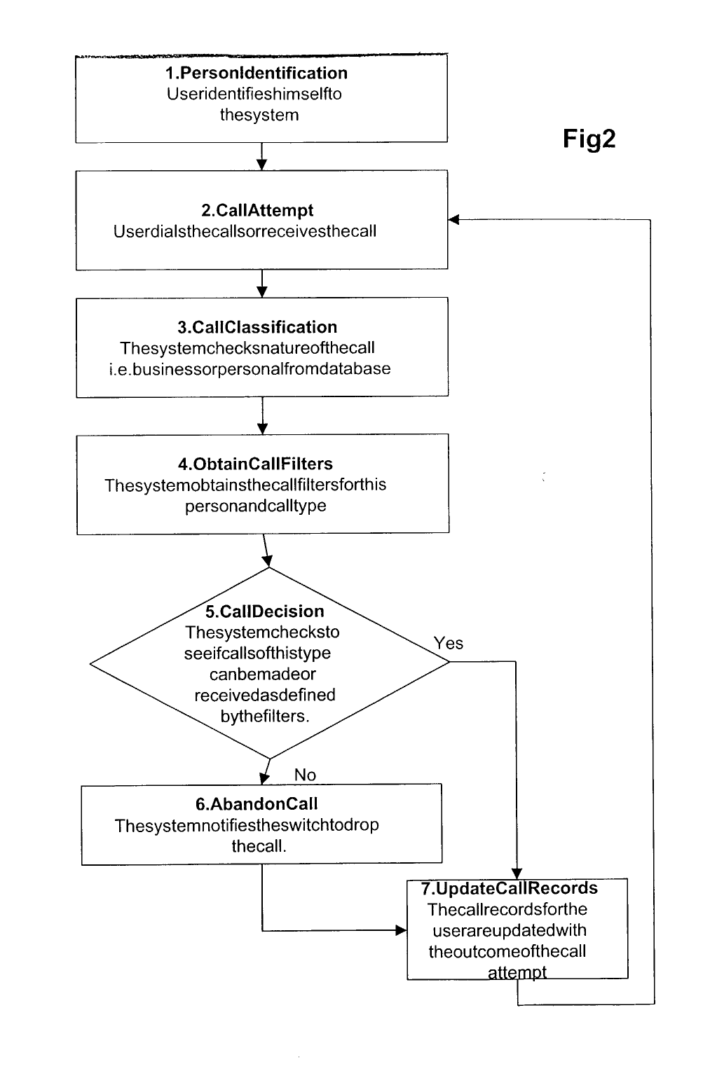

FIG. 2 is a simplified flow diagram illustrating operative steps of the determination control routine to an embodiment of the present invention. When this routine is called, operation begins by identifying the user.

The person identification begins with the user authenticating themselves to the system through a number of possible means. The user could make a login on the telephone set and this would make them known to the PBX. Subsequently, the PBX would send a CTI message to the CTI Server updating it accordingly. A user could also choose to login via a software on the desktop commonly referred to as SoftPhone by those familiar with the art. This SoftPhone would communicate with the PBX via the CTI Server. This too would make the PBX send the same message to the CTI Server.

The user would then at some time make an attempt at dialling a call. This attempt could be initiated from the telephone set or via the SoftPhone application. The messages associated with this attempt would be passed on to the SCB application.

The SCB application would check within the database to classify the type of call in relation to the party who has initiated the call attempt. If the database returns no data on the call attempt, the person initiating the call is requested to classify the call as business or personal.

Once the call has been classified, the application then proceeds to check if the rules within the system are allowing calls of this nature to take place. The outcome of this is to either abandon the call attempt by issuing a “hang up” message to the CTI Server and through to the PBX or to allow the call to take place.

All call attempt outcomes from this application are recorded within the database.

A simplified visualisation of determining the various common combinations of a call attempt can be set out as follows:

| | |
|---|---|
| 1. | Person Identification (Login via telephone, CTI or via network) |
| a. | User log into the telephone set and generates CTI message; or |
| b. | User logs in via SoftPhone and generates CTI message; or |
| c. | User logs in to the desktop session and generates |
| | application message. |
| 2. | Call Attempt (Call made by telephone or through CTI) |
| a. | User keys in number via telephone; or |
| b. | User types in or selects number via SoftPhone. |
| 3. | Call Classification (DB Dip or via screen prompt) |
| a. | Call is checked for classification from database; and if |
| | necessary |
| b. | Call is questioned via screen-prompt. |
| 4. | Obtain Call Filters |
| a. | The call filters for the user are obtained from the database; |
| | and/or |
| b. | The call filters for this type of call are obtained from the |
| | database. |
| 5. | Call Decision (Call attempt approved or denied) |
| a. | All calls are barred per se; or |
| b. | All calls are barred dependant on environment load; or |
| c. | Calls are barred as set by user filters; or |
| d. | Calls are barred as set by filters for this call; or |
| e. | Call not barred. |
| 6. | Update Call Records |
| a. | The call record within the database are updated for this call |
| | attempt. |

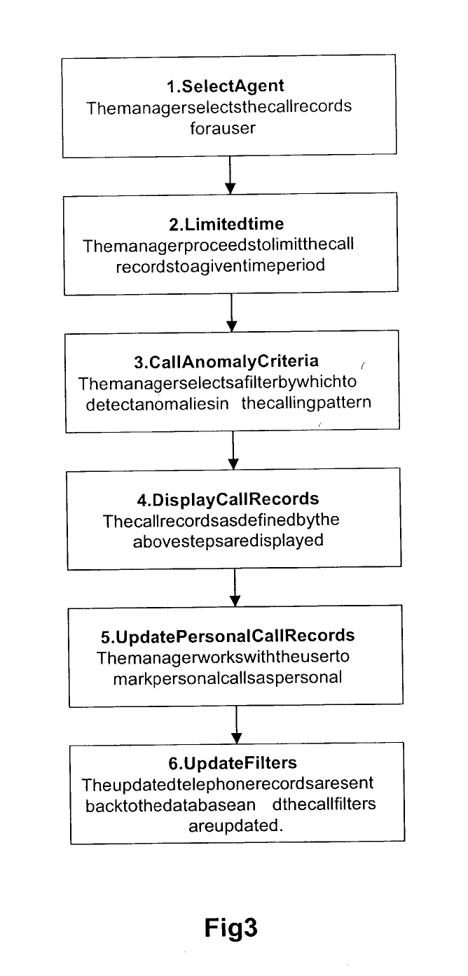

FIG. 3 is a simplified flow diagram illustrating operative steps of a “filtering by exclusion” reporting and tagging of the call records according to the embodiment of the present invention.

FIG. 3 shows the step pertaining to displaying and tagging calls by using a “filtering by exclusion” mechanism. This works by allowing the manager and the user to filter out calls which are individually selected and excluded from being of a business nature. This involves a working model by which the manager and the user can continue to evolve the system by continuous updates on a regular basis.

The manager starts by selecting a user for whom the call records need to be updated prior to the call filters being modified. He then proceeds to specify the time range for the call records. He then selects the criteria by which to highlight the anomalies within the call records. Anomalies are detected in call records by finding calls which are not part of the normal calling routine. For instance agents within call centres are not generally expected to build one to one relationships with customers. Therefore an agent receiving more than his fair share of calls from a customer can be considered as out of the normal. Likewise calls by a user to a particular telephone number with high talk times can be considered as suspicious. These anomaly filters select calls which are of extraordinary type i.e. called more than average, call times of higher or lower than average or called at specific times. In actual implementation these filters are merely different ways of viewing a data set as defined within a database but made relevant to call data records (CDR).

The manager then views the call records within the time range specified along with the suspicious call records highlighted. At this point the manager and the user can work through the call records and tag those calls which were definitely not of a business nature. All call records for tagged calls are updated. Also, all tagged telephone numbers are immediately set as filters for that particular user.

This process of “filtering by exclusion” allows the system to evolve over a period of time.

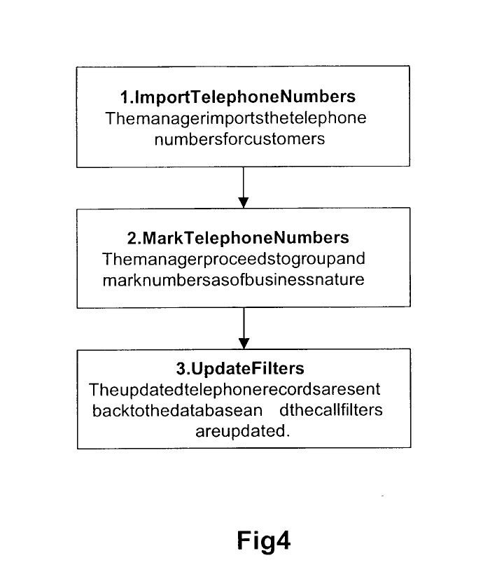

FIG. 4 is a simplified flow diagram illustrating operative steps of the “filtering by inclusion” reporting and tagging of the call records according to an embodiment of the present invention.

This introduces the acceptable business telephone numbers into the system as selected by the manager. This mechanism then accepts that telephone calls to these numbers are acceptable as being of a business nature.

The manager starts by importing a selection of telephone numbers into the system. These are then selected and highlighted as of a business nature. A typical list for a call centre would contain telephone numbers of all current customers. This ensures that the application has call data from which to start. Call filters are created for these telephone numbers to allow all calls from to these numbers to be classified as business calls.

All calls not within the list will be recorded as of non-business nature until they have been endorsed by the “filtering by exclusion” process.

Various modifications to the preferred embodiments described will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

What is claimed:

1. A telephony method in a local telephony system for selectively barring calls outside the system for a system user including the steps of: compiling a list of telephone numbers tagged as personal numbers specific to the user; determining a busy time when there is a level of call activity above an activity threshold; and barring specific user calls corresponding to the personal numbers during the busy time.

2. A telephony method according to claim 1 wherein calls are barred by globally monitoring calls to determine a busy period.

3. A telephony method according to claim 1, wherein calls are barred by personal monitoring with respect to agent workload to determine a busy period.

4. A telephony method according to claim 1 wherein calls are tagged in various classes with differing priority levels, the lower priority levels having differing barring thresholds.

5. A telephony method according to claim 1 wherein the list of telephone numbers is compiled by tagging numbers in a periodic review of calls for each user.

6. A telephony method according to claim 1 wherein the list is updated as a result of a call.

7. A telephony method according to claim 1 which uses intelligent rules to selectively bar numbers in addition to the user specific soft barring.

8. A telephony method according to claim 1 wherein the method bars all calls to certain numbers, classified as global bar numbers.

9. A telephony method according to claim 1 wherein predetermined user group bar numbers are barred to certain groups of users.

10. A telephony method according to claim 1 further including user-specific hard call-barring.

11. A telephony method according to claim 1 wherein one or all of the additional barring rules refers to number ranges rather than a single telephone number.

12. A telephony method according to claim 1 wherein additional bars are held as rules in a database.

13. A telephony method according to claim 1 wherein the method is a computer telephony integration (CTI) method on a single or on multiple sites.

14. A telephony method according to claim 1 wherein the system user is an agent in a call centre and the local telephony system is a call centre.

15. A telephony method according to claim 1 wherein the system user is an office worker and the local telephony system is a private branch exchange (PBX).

16. A telephony method according to claim 1 wherein one or more system user(s) may be a remote agent/office worker connected over a network to the local telephony system.

17. A telephony method in a local telephony system for screening and selectively barring calls outside the system for a system user including the steps of: the user receiving or making a telephone call outside the system; classification of the call according to how the outside number is tagged in a database of outside numbers; checking call filters relating to level of system activity and call classification; barring the call if the number is tagged as personal and the level of system activity is above a certain threshold; and allowing the call to proceed if it has not been barred.

18. A telephony method according to claim 17 wherein the method includes the step of checking the database for call filters other than user-specific soft call-barring, and barring the call if there is another bar on the number which is relevant to the user.

19. A telephony method according to claim 17 including an initial step of the user logging into the system, preferably by entering an ID code.

20. A telephony method according to claim 17 including the step of updating call records once the call has been successfully completed or rejected.

21. A method according to claim 17 which is suitable to bar both incoming and outgoing calls.

22. A local telephony system comprising a telephony switch for call distribution within the local system; at least one telephone attached to the switch, a computer system connected to the switch, including a database containing telephone numbers outside the local system selectively tagged as personal numbers specific to a system user and at least one filter to disallow personal calls during times when there is a level of activity above a certain threshold; and a soft call barring application in communication with the database, wherein the soft call barring application selectively bars specific user calls corresponding to personal numbers during the busy time.

23. A local telephony system suitable for attachment to the public switched telephone network (PSTN) comprising a telephony switch for call distribution within the local system; at least one telephone attached to the switch, a computer system connected to the switch, including a database containing telephone numbers outside the local system selectively tagged as personal numbers specific to a system user and at least one filter to disallow personal calls during times when there is a level of activity above a certain threshold; a CTI function attached to the switch and the database and a soft call barring application in communication with the database and CTI function, wherein the soft call barring application selectively bars specific user calls corresponding to personal numbers during the busy time.

24. A telephony system according to claim 23 in which some users do not have access to a computer.

25. A telephony system according to claim 23 wherein the system user's telephone is connected to the switch and the system user's computer is connected to the computer network with no direct communication between the telephone and computer.

26. A telephony system according to claim 23 wherein the CTI function is part of a “soft switch”.

27. A telephony system according to claim 23 wherein the CTI function is provided as a CTI server linking the switch to the computer system.

28. A telephony system according to claim 23 wherein the system incorporates a SOHO (single office/home office) facility.

29. A telephony system according claim 23 wherein the switch is an ACD (automatic call distribution) switch, or a PBX (private branch exchange) switch or VoIP (voice over internet protocol) switch or PSTN (public switched telephone network) switch.

30. A soft call barring application for use in a local telephony system comprising suitable functionality for selectively barring calls outside the system for a system user by: compiling a list of telephone numbers tagged as personal numbers specific to the user; determining a busy time when there is a level of call activity above an activity threshold; and barring specific user calls corresponding to the personal numbers during the busy time.

31. A soft call-barring program set for use in a local telephony system comprising a soft call-barring application with suitable functionality for selectively barring calls outside the system for a system user by: compiling a list of telephone numbers tagged as personal numbers specific to the user; determining a busy time when there is a level of call activity above an activity threshold; and barring specific user calls corresponding to the personal numbers during the busy time and a database schema for storing the telephone numbers and their tags.
